(19) United States
(12) Patent Application Publication
(10) Pub. No.: US 2007/0168202 A1
(43) Pub. Date: Jul. 19, 2007

(54) Restaurant drive-through monitoring system

(75) Inventors: Atul Changela, Huntersville, NC (US); Christopher Sebes, Charlotte, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Xpient Solutions, LLC, Charlote, NC (US)

(21) Appl. No.: 11/329,007

(22) Filed: Jan. 10, 2006

(51) Int. Cl. G06Q 99/00

(52) U.S. Cl. 705/1

(57) ABSTRACT

A system for tracking a speed of service at a restaurant for a vehicle receives an indicator that the vehicle is present in a menu board area from a first detector, and receives an indicator that an order for the vehicle is entered at a POS device. The system then receives an indicator that the vehicle is present in a service window area from a second detector. Based on the received information, the system can calculate the greet time, menu board time and service window time for the vehicle. Further, the system can generate reports and display information that correlates POS information, such as menu details of an order, with loop detector information.

### FIELD OF THE INVENTION

One embodiment of the present invention is directed to a restaurant drive-through monitoring system. More particularly, one embodiment of the present invention is directed to a restaurant drive-through monitoring system that integrates point of sale and detector data.

### BACKGROUND INFORMATION

Prior art systems exist for measuring the speed of service at a drive-through of a quick service restaurant. Usually these known systems include a loop detector buried in concrete, typically at the menu board, which senses the weight of the car. The loop detector can determine when the car reaches the menu board and when it leaves. Generally the loop detector is used to trigger a timer in the store that records the total elapsed time that the customer's car is at the menu board.

Prior art system for restaurants that are focused more heavily on speed of service measurements use a second loop detector buried at the drive-through window or service window (i.e., the window where the food is given to the customer). Two loop detectors are used to provide a more complete picture of speed of service by determining how much time the customer spent at the menu board, how much time they spent at the drive-though window, and the total time involved in serving them.

Restaurants that display and capture speed of service information have been forced to do so using prior art proprietary hardware devices. One problem with this approach is that the hardware is typically expensive. The time information captured from the loop detector is usually displayed on an LED panel. If able to be stored, the data may be used to generate low level reports, but these are independent of, not linked to, specific sales transaction information from the point of sale (“POS”) system.

With restaurants using prior art monitoring systems, employees typically glance from time to time at the display that shows how long the current customer has been waiting. The manager is undoubtedly aware of the importance of speed of service and, when he or she has a free minute, will check what's on the display. But, chances are, this will probably be when the store is least busy.

Optimizing speed of service and accuracy of orders are the twin keys to success for quick service restaurant operations. Many operators, hoping to maintain a focus on this most critical element of their business, implement an LED display-based timing system to visibly encourage a store-level focus on speed of service. The result over time is the following experience cycle—top management perceives a speed of service problem or opportunity; a corporate directive re-emphasizes speed of service; for a period of time store performance is better; then, inevitably, the store returns to “a level of normalcy,” resuming its other-than-best practices. The net result is that most operators realize a less-than-optimized, long-term performance. And, the cycle repeats itself —again and again.

There are several major problems with the current prior art systems for monitoring drive-through operations. First of all, only a limited amount of information is captured. Unless someone is standing around taking down the information on a clipboard, for other than greet time, current systems do not know how much of the time was spent waiting for the clerk to take the order, and how much was menu time—actually taking order. Even for systems having a loop detector at the drive-through window, current systems do not track how much of time spent at the window was involved with paying, how long the customer waited for their order, and how long they may have remained at the window after their order was filled.

Using current systems, there is also a lot of other missing information that, if known, might help increase an understanding of why times are high or low and what could be done to improve them. For example, the size and the composition of the order explain many variations in drive-through time. A restaurant may easily be willing to accept a 240-second time for a $50 order. Or, a pattern may be spotted where kitchen time is always 15 to 30 seconds higher when a particular sandwich is ordered. Or, what if times tend to rise when a specific employee is tasked with working the payment window? While it is possible to make improvements to speed of service, it is impossible to know what additional improvements might be made if all elements of the customer's speed of service experience could be analyzed.

Another drawback with current solutions is the difficulty of accessing and interpreting the information captured by loop detectors. In most cases, systems are capable of storing historical drive-through times, but this information is often not very useful because if reviewed at all, it is typically done long after the fact and outside the context of the order which generated that data. Scrolling through accumulated reported numbers, it is usually very difficult to understand historical incidents such as why drive-though times shot sky-high for an extended period on a particular day. With current systems it takes a considerable amount of time to identify, diagnose, and solve problems that may be increasing drive-through times. Smaller problems may never even be known, much less solved.

Based on the foregoing, there is a need for an improved system for monitoring drive-through service in a restaurant.

### SUMMARY OF THE INVENTION

One embodiment of the present invention is a system for tracking a speed of service at a restaurant for a vehicle. The system receives an indicator that the vehicle is present in a menu board area from a first detector, and receives an indicator that an order for the vehicle is entered at a POS device. The system then receives an indicator that the vehicle is present in a service window area from a second detector. Based on the received information, the system can calculate the greet time, menu board time and service window time for the vehicle. Further, the system can generate reports and display information that correlates POS information, such as menu details of an order, with loop detector information.

### BRIEF DESCRIPTION OF THE DRAWINGS

FIG. 1 is a block diagram of a drive-through monitoring system in accordance with one embodiment of the present invention.

FIGS. 2 and 3 are graphical reports illustrating examples of data generated by embodiments of the present invention.

### DETAILED DESCRIPTION

One embodiment of the present invention is a system that fully integrates loop detectors with POS devices to dramatically improve speed of service measurements. The integration makes it possible to understand the various elements of an individual customer's speed of service experience and present the information in both a real-time and an after-the-fact basis not only to the individual restaurant or store, but also to any person within an organization that can make use of it.

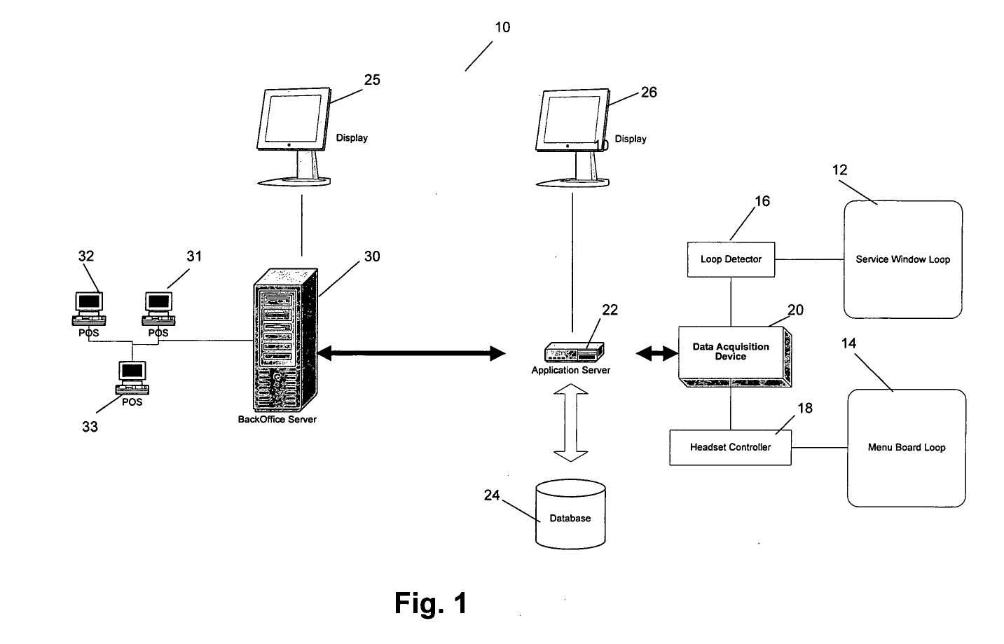

FIG. 1 is a block diagram of a drive-through monitoring system 10 in accordance with one embodiment of the present invention. System 10 includes a menu board loop 14 and a service window loop 12 that are located in the drive-through lane of the restaurant in a known manner. In one embodiment, loops 12 and 14 are electrical circuits buried under the drive-through lane that generate a change in voltage when a vehicle enters the respective portion of the drive-through lane.

Menu board loop 14 is coupled to a headset controller 18, which functions, among other things, as a loop detector. Headset controller 18 receives an indicator from menu board loop 14 when a vehicle is present at the menu board, and generates a signal when a customer in the vehicle is being greeted. Service window loop 12 is coupled to a loop detector 16 which receives an indicator from service window loop 12 when a vehicle is present. A data acquisition device 20 converts the analog signals received from loop detector 16 and headset controller 18 into digital signals. In other embodiments, a loop detector instead of headset controller 18 can be coupled to data acquisition device 20.

System 10 further includes an application server 22. Application server 22 in one embodiment is a general purpose computer that includes a general purpose processor and a memory device for storing instructions executed by the processor. Application server 22 is coupled to data acquisition device 20 and receives the digital signals that indicate when a vehicle has entered the menu board, and the service window, and when the customer has been greeted. Application server 22 is further coupled to a display 26 and a database 24. In one embodiment, database 24 is a structured query language (“SQL”) database.

System 10 further includes a back office server 30. Back office server 30 in one embodiment is a general purpose computer that includes a general purpose processor and a memory device for storing instructions executed by the processor. Back office server 30 is coupled to application server 22 and can be located in the back office of the restaurant, or remotely located in communication with application server 22. POS devices 31-33 and a display 25 are coupled to back office server 30. POS devices 31-33 can all be located in the same restaurant or can be located in different restaurants. POS transaction data is sent from POS devices 31-33 to back office server 30. The POS transaction data can then be stored in database 24 through application server 22.

System 10 integrates POS data and loop data into database 24, which makes it possible to better understand the various components that make up speed of service by tracking and integrating the time information generated by loops 12 and 14 with the data generated by each POS transaction at POS devices 31-33. For example, at the beginning of the ordering process the menu board loop 14 indicates when the customer drives up to the menu board; then the POS device 31-33 where the order is to be entered indicates when the employee started entering the order and when the order was completed. Service window loop 12 then indicates when the car drove toward the service window. The time spent at the menu board can now be divided into greet time, menu time, and order time. When speed of service increases or decreases, one can look at all of the time components that comprise the customer's speed of service experience to understand which specific component is enhancing or detracting from speed of service goals (e.g., is the delay possibly caused by the customer sitting at the payment window for one minute before their order is tendered on the POS terminal?). In another embodiment, the time that the employee keys the microphone at headset controller 18 to greet the customer is recorded, and this time, rather than when the employee started to enter the order, is used to calculate the greet time.

Further, system 10 allows for enhanced financial control by being able to track the number of cars and correlate that number, less drive-offs, with the number of POS transactions. By recording the value of the order that was generated at the menu board and comparing it to the amount of the order at the point of tender, the operator has the ability to monitor the potential for “silent partnering” behavior (i.e., stealing by restaurant employees).

Integration between loops 12 and 14 and POS devices 31-33 in embodiments of the present invention also provide access to order and personnel information which helps provide further understanding of the factors driving speed of service. For example, queries of database 24 provides ability to determine how speed of service is related to order size and content. Without understanding the underlying cause, a planned corrective action may address the apparent symptom but may be the wrong action to correct the real problem. For example, it may be discovered that while the drive-through time has increased in a particular store, it is because the employees are doing a better job of upselling, not because of an operational problem that may be incorrectly assumed without access to complete data.

As a further example, the majority of your orders may be completed promptly, but, a relatively small percentage of orders containing certain menu items are driving up the average time. This may indicate that the problem is most likely not at the store level but rather needs to be addressed by correcting either menu issues or kitchen techniques. The inherent ability to extract speed of service exceptions with the specific crew involved in that order provides unique data for analyzing performance. Managers can see how their people are doing and provide the additional training or make the personnel changes that are needed to achieve the desired results.

The speed of service information captured by system 10 in database 24 can be queried in many different ways to produce reports in the format that works best for every area of an organization. For example, high-level managers of many restaurants will generally want to look at the region and store level information in order to identify high and low performers, to then migrate best practices. Menu engineering will be enhanced by examining the impact of product mix on variations in the speed of service times.

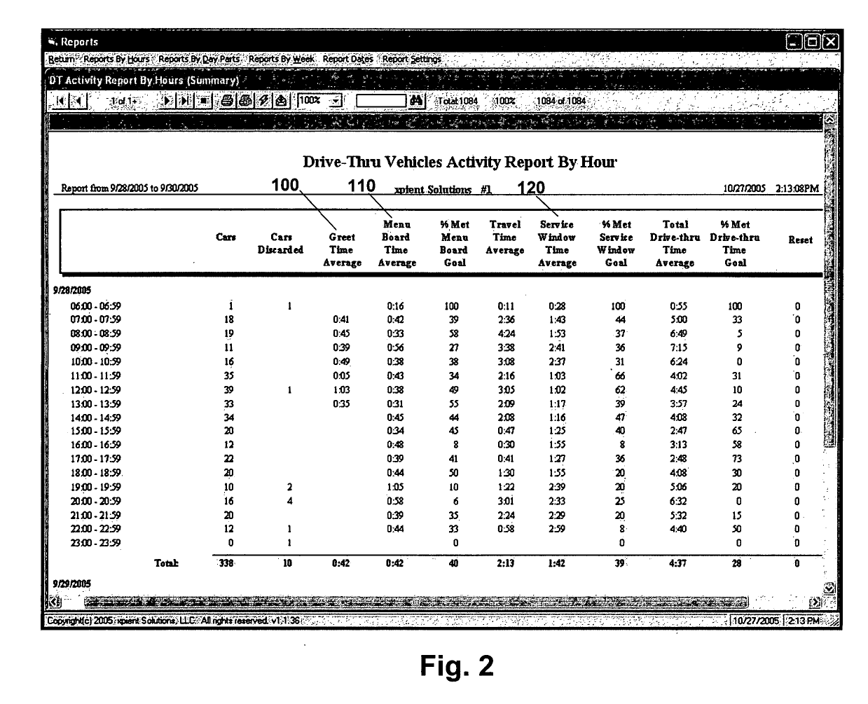

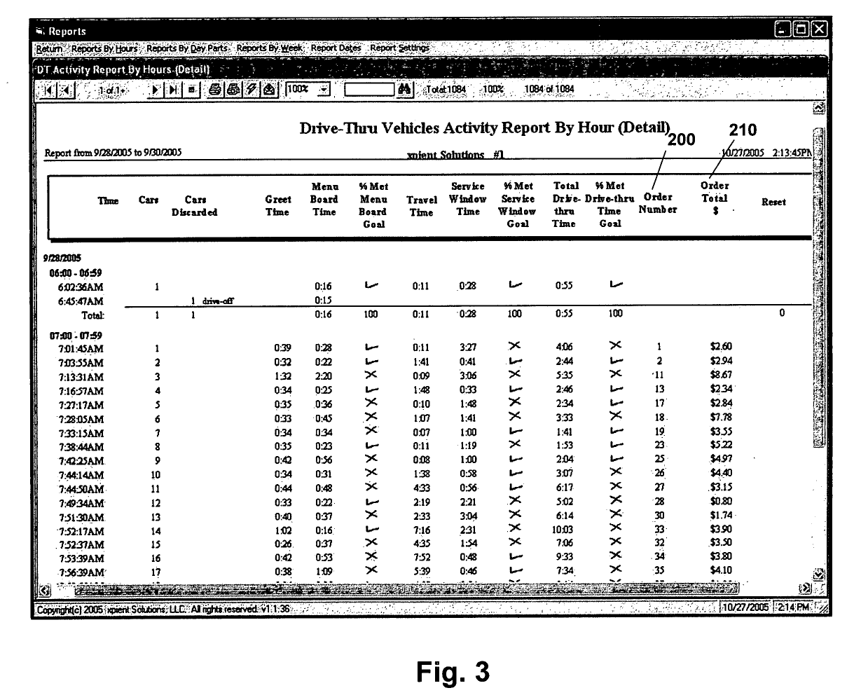

FIGS. 2 and 3 are graphical reports illustrating examples of data generated by embodiments of the present invention. Reports such as in FIGS. 2 and 3 are generated through queries of database 24 at back office server 30 in one embodiment. The reports may be printed, or displayed on display 26 (for use of the kitchen crew) or on display 25 (for use of management, either local or remote from the restaurant). Displays 25 and 26 are completely programmable to display any data, in any form, that is stored in database 24 or that is captured in real time.

In FIG. 2, a greet time average (column 100), menu board time average (column 110) and service window time average (column 120) are examples of time measurements that are possible through the integration of loop data and POS data in accordance with one embodiment of the present invention. FIG. 3 goes further in linking this data to a specific order number (column 200) and the total dollar amount of each order (column 210).

Further data regarding each order is stored in database 24 and can also be displayed in a report. For example, the type of food that made up each order can be displayed so that orders that took too long can be linked to certain food items. Any other information generated at POS devices 31-33 can also be correlated with loop data, such as the name of an employee per each car served. Further examples of data that can be displayed in a report according to embodiments of the present invention include:
The amount of time each vehicle remains on the Menu Board pad;
The average time for vehicles on the Menu Board pad per employee shift, daypart, or business day;
The amount of time for each vehicle at the drive-thru window;
The average time for vehicles at the drive-thru window per employee shift, daypart, or business day;
The average total drive-thru time for the current business day;
The greatest drive-thru time;
The number of vehicles serviced per day by employee shift, daypart or business day;
The current percentage of a specified drive-thru goal; and
The “Best Hour” for the current business day.

One advantage of the fully integrated speed of service system approach in accordance with embodiments of the present invention is that, instead of sending data in a batch mode as is done by prior art systems, the speed of service information is written in real-time to SQL Database 24 where it can be easily accessed by other applications and combined with other data sources, to generate reports and alerts. Although most existing speed of service technology can upload speed of service data with other daily information that is polled from the store, embodiments of the present invention combine all of the speed of service information with each specific POS order prior to uploading the data to the corporate database. Delivering fully integrated transaction data to the home office facilitates issue analysis and any correspondingly appropriate, pro-active decision-making.

The use of alerts with embodiments of the present invention enable an enterprise to create business rules that establish performance benchmarks for the operation. The alerts are typically deployed within the enterprise's various control systems (the POS, back-office and enterprise reporting functions), and monitor predetermined levels of business performance. When performance falls below or exceeds the benchmarks determined in the established business rules, the system notifies designated managers with this information. The ability to receive such critical information in real-time renders it actionable, and enables management to immediately respond with necessary adjustments to optimize the efficiency of their operation.

System 10 can be configured to issue alerts via email, pager, or text message in the event that drive-through times exceed pre-set maximums. For example, suppose the target in a particular store is 90 seconds. The alert could be configured so that if the average drive-through time rises above 120 seconds for more than 30 minutes, then any of various predetermined alert mechanisms is triggered (for example a text message is directed to the area manager's mobile phone). The alert can be escalated further up the organization should a corrective action not have been taken within a predetermined period of time.

The alerts are also configured to minimize false alarms. For example, in a 24-hour store, the speed of service targets might be configured at 90 seconds during the lunch hour and 180 seconds at 3 a.m., because the store is more lightly staffed and there is less pressure on the customer's time. Automating the process of dissecting the data in accordance with embodiments of the present invention makes it possible for area or district managers to spend their time at the stores that need attention rather than simply paying random visits. With store personnel aware that speed of service is being closely monitored, their need to focus more attention to this critical performance metric is reinforced.

Specific implementation details of one embodiment of the present invention is disclosed below:

In embodiments of the present invention, the vehicle times are written to database 24 and used to track speed of service and average service time calculations. An analog-to-digital converter in data acquisition device 20 is used to detect the voltage change from detector/loops 12 and 14. The change in voltage is translated into a state indicating if the vehicle has entered or exited the area detector.

Embodiments of the present invention track vehicles using a simple first in first out algorithm. Vehicles can be assigned a tag ID as they enter the menu board. The same tag ID can be used as the vehicle enters the service window.

An assumption is made that all vehicles pass through both detectors (loops 12 and 14) during the day. A drive off condition is encountered when a vehicle enters the lane at the menu board and then drives off without passing through the service window. Embodiments of the present invention use a configurable time limit to detect a vehicle that appears to be trapped in the lane for an excessive period of time. The timer starts when the vehicle leaves the menu board. If a vehicle does not make it to the service window within the set time limit and there is no vehicle at the service window, then the system removes the vehicle from its internal list of vehicles in the lane and marks the vehicle as a drive-off car in the database.

A drive on condition is encountered when a vehicle suddenly drives up to the service window without passing through the menu board. The vehicle is assigned a new Tag ID and the vehicle is marked as a drive-on vehicle

Menu board service time represents the time a vehicle is on the menu board pad. The total time divided by the total number of vehicles represents the average time. The service window service time represents the time a vehicle is on the service window pad. The total time divided by the total number of vehicles represents the average time.

As disclosed, the system in accordance with embodiments of the present invention combines loop detector data and POS data to provide a more complete picture of speed of service relative to a restaurant drive-through.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of tracking a speed of service at a restaurant for a vehicle, said method comprising:
receiving a first indicator that the vehicle is present in a menu board area from a first detector;
receiving a second indicator that an order for the vehicle is initiated; and
receiving a third indicator that the vehicle is present in a service window area from a second detector.

2. The method of claim 1, wherein said second indicator includes a time when the order initially is entered in a point of sale device.

3. The method of claim 2, further comprising:
calculating a greet time for the vehicle; and
calculating a menu board time for the vehicle.

4. The method of claim 3, further comprising:
calculating a service window time for the vehicle.

5. The method of claim 1, further receiving an amount of the order.

6. The method of claim 1, wherein said first detector is a first loop detector coupled to a first loop and said second detector is a second loop detector coupled to a second loop.

7. The method of claim 1, wherein said first detector is a headset.

8. The method of claim 4, further comprising:
displaying the greet time, menu board time and service window time.

9. The method of claim 4, further comprising:
calculating a total drive through time for the vehicle.

10. A system for measuring speed of speed of service at a restaurant for a vehicle, said system comprising:
a first detector for detecting that the vehicle is present in a menu board area;
a second detector for detecting that the vehicle is present in a service window area;
a point of sale device; and
a processor coupled to said first and second detector and said point of sale device, said processor programmed to calculate a greet time for the vehicle and a menu board time for the vehicle.

11. The system of claim 10, wherein said processor is programmed to receive a first time when the order initially is entered in the point of sale device, and a second time when the order was completed being entered in the point of sale device.

12. The system of claim 11, wherein said processor is programmed to calculate a service window time for the vehicle.

13. The system of claim 1, wherein said processor is programmed to receive an amount of the order from the point of sale device.

14. The system of claim 10, wherein said first detector is a first loop detector coupled to a first loop and said second detector is a second loop detector coupled to a second loop.

15. The system of claim 10, wherein said first detector is a headset.

16. The system of claim 12, further comprising a display for displaying the greet time, menu board time and service window time.

17. The system of claim 12, wherein said processor is programmed to calculate a total drive-through time for the vehicle.

18. A computer readable medium having instructions stored thereon that, when executed by a processor, cause the processor to:
receive a first indicator that a vehicle is present in a menu board area from a first detector;
receive a second indicator that an order for the vehicle is entered at a point of sale device;
receive a third indicator that the vehicle is present in a service window area from a second detector;
calculate a greet time for the vehicle based on said first and second indicators; and
calculate a menu board time for the vehicle based on said first and second indicators.

19. The computer readable medium of claim 18, said instructions further causing said processor to:
calculate a service window time for the vehicle based on said third indicator.

20. The computer readable medium of claim 19, said instructions further causing said processor to:
calculate a total drive-through time for the vehicle.

21. The method of claim 7, wherein said second indicator includes a time when a microphone on the headset is keyed.
